(19) United States
(12) Patent Application Publication
(10) Pub. No.: US 2014/0102731 A1
(43) Pub. Date: Apr. 17, 2014

(54) METHOD FOR EMERGENCY COOLING AND EXTINGUISHING A BATTERY OF A WATER VEHICLE, BATTERY AND WATER VEHICLE

(71) Applicant: MTU Friedrichshafen GmbH, Friedrichshafen (DE)

(72) Inventors: Peter Riegger, Ueberlingen (DE); Gerhard Filip, Markdorf (DE)

(73) Assignee: MTU Friedrichshafen GmbH, Friedrichshafen (DE)

(21) Appl. No.: 14/089,725

(22) Filed: Nov. 25, 2013

Related U.S. Application Data
(63) Continuation-in-part of application No. PCT/EP2012/002212, filed on May 24, 2012.

(30) Foreign Application Priority Data
May 26, 2011 (DE) 10 2011 076 536.0

(51) Int. Cl. A62C 3/10; A62C 2/00; H01M 10/625

(52) U.S. Cl. CPC A62C 3/10; H01M 10/5016; A62C 2/00
USPC 169/45; 429/120; 429/56; 169/46

(57) ABSTRACT

In a method tor the emergency cooling of a battery or an emergency extinguishing of the battery of a water vehicle including such a battery with a watertight containment, upon determination of an emergency, the battery is flooded by ambient water drawn from around the water vehicle.

This is a Continuation-In-Part application of pending international patent application PCT/EP2012/002212 filed May 24, 2012 and claiming the priority of German patent application 10 2011 076 356.0 filed May 26, 2011.

### BACKGROUND OF THE INVENTION

The invention concerns a method for emergency cooling a battery and/or emergency extinguishing a battery fire of a water vehicle as well as a battery for a water vehicle and also a water vehicle provided with such a battery.

It is known that a lithium-ion battery can catch fire when it reaches a temperature range suitable to cause ignition of the chemicals present in such a battery. Dependent on the materials used and the initiation factors, there is a real danger for ignition. The ignition may be caused, for example, by excessive charging beyond the admissible final charging voltage, overheating by an excessive load, mechanical damage to the battery, internal faults or similar. These conditions may occur in particular when a water vehicle including such a battery is in an emergency situation. In the process, not only heat is released because of open flames but also hot and dangerous gases are generated which may even further deteriorate the emergency situation in which the water vehicle is involved.

It is known to discharge such gases via a pressure release line at a location where they cannot become dangerous to people. It is however difficult to extinguish a fire of a battery which generally includes oxygen donors once the battery has ignited. It is therefore common to strictly adhere to preventative measures which prevent the ignition of a battery in the first place. This involves in particular maintaining admissible operating conditions such as the temperature of the battery by a constant monitoring of the operating temperature of the cells of a battery. Such monitoring is generally performed by a battery management system (BMS) which is capable of switching the battery off when a possible emergency is recognized.

The problem in this connection however is that the battery may be switched off too early and, as a result, its power is not available in an emergency up to the last moment just when it may be needed most. On the other hand, in connection with large batteries including several cells, there is the possibility that, although the battery management system may be able to switch off the battery in case of a malfunction, it may basically no longer be possible to immediately discharge the battery. As a result, even in case of an emergency shutdown of the battery, there is still the possibility that the energy stored in the battery may be released uncontrollably.

In order to manage such error scenarios, which make an energy release unavoidable the battery housing is additionally packaged into a containment which can withstand a potential energy release and also the potential fire load of the components and chemicals present at least until the danger area can be cleared.

But in particular in connection with ships, such an error situation is extremely undesirable since it may require the removal of the passengers and the crew. In addition, in particular in connection with ships consisting of materials which are not temperature resistant such as the common plastic materials or similar, an open battery fire may lead to leakages which, in an extreme case, may even result in the sinking of the ship.

It is of course desirable to safely prevent a battery ignition by additional safety measures.

It is therefore the object of the present invention to provide a method and a battery as well as a water vehicle with a battery wherein a battery fire is safely prevented. A concept should be provided which operates independently of a usual cooling system. In particular, the concept should function automatically in particular also when other emergency systems fail.

### SUMMARY OF THE INVENTION

In a method for the emergency cooling of a battery or an emergency extinguishing of the battery of a water vehicle including such a battery with a watertight containment, upon determination of an emergency, the battery is flooded by ambient water drawn from around the water vehicle.

The invention is based on the consideration that water vehicles have an advantage over land vehicles in that water is readily available in a practically unlimited amount. Although in stationary arrangements such as a common cooling system of a battery, water can be supplied in sufficient amounts, this is not possible in connection with land and air vehicles and also with water vehicles because it is impossible to carry along the water amounts necessary for that purpose. But the inventor has recognized that, in an emergency, the ambient water of a water vehicle is suitable for flooding the battery and accordingly suitable to avoid an undesirable release of energy into the water vehicle body or, in the worst case, to prevent a battery fire.

The inventor has recognized that as “Ultima Ratio” (in the final analysis) the battery of a water vehicle, particularly in a condition in which it cannot be saved anyhow, can be flooded with ambient water well knowing that the battery may be damaged thereby to an extent that it cannot be repaired. This applies especially to a lithium ion battery which, because of the nature of the materials of which it consists, is particularly sensitive to energy releasing or fire-causing accidents. The invention is based on the recognition that the usual water cooling systems for a battery—particularly in an emergency—may not have sufficient cooling or fire-extinguishing water available in case of an excessive release of energy since, particularly in an emergency, a normal water cooling system may not have sufficient water capacity. The concept according to the invention eliminates these disadvantages and results in a safe fire prevention capability or respectively at least in a prevention of an uncontrolled energy release or an explosion of the battery.

Advantageous further developments of the invention are referred to in the subclaims, which cover advantageous embodiments of the concept explained above for solving the object of the invention and for realizing further advantages.

In connection with the method according to the invention, the concept is particularly helpful in the event of an emergency overheating of the battery. In accordance with the invention flooding of the battery by ambient water is provided for already in that case.

In connection with the invention, it is already considered to be an accident when it is determined that the battery can no longer be shut down by the battery management system that is the battery can no longer be safely discharged even if it would be switched off. Accordingly, in the unlikely event of an accident where the battery is overheated to the extent that neither the battery management system nor a switching off could prevent a battery fire, it must be assumed that the battery has suffered permanent damage and has become a danger to the ambient. In accordance with this second development further escalation or deterioration of the state of the battery may be considered to be likely so that in this case the battery could and should be flooded by ambient water although the battery may be destroyed thereby.

In accordance with a third development concerning a further escalation of the emergency, it is determined that the temperature of the battery approaches a range where an explosion can be expected. Also, in this case, a flooding of the battery by ambient water should be provided for.

For initiating the concept, flooding of the battery by means of an emergency system including an ambient water supply line is provided. In this way, the emergency cooling system for the battery is independent of the normal battery cooling system. The ambient water supply line is in communication with the ambient water. The ambient water supply line is a separate line which may include a pump but does not need to include a pump.

In a preferred embodiment of the invention, the battery is flooded in case of a release of the battery pressure. It has been found particularly suitable to flood the battery automatically upon release of the pressure. This particularly preferred concept is based on the idea that, on one hand, a pressure release of the battery can be acceptable in an emergency and, on the other, needs to be followed up by a flooding of the battery by ambient water in order to avoid worse results. The embodiment is based on the assumption that, in this case, the battery containment is in sufficiently good shape to permit a controlled flooding of the battery. Based hereon, another preferred embodiment provides for a flooding of the battery via the rupture of a disc. Generally, during normal operation, a pressure release opening may be closed by a rupture disc in order to prevent the infiltration of moisture dust or similar foreign parts into the battery containment. In water vehicles, it is possible however, as recognized in connection with a further embodiment of the invention, that the pressure release rupture disc, which remains sealed up to a certain pressure above the normal containment pressure, can be installed in a containment opening pressure- and water-tight manner. It is particularly preferred to perform flooding automatically using water from below the water surface. This is particularly advantageously achievable if the rupture disc is arranged at a level below the surface of the water line of the water vehicle body. For example, the battery may be arranged in the water vehicle hull below the water line and an ambient water line may be connected to the rupture disc and extends to a hull outlet covered by ambient water.

In accordance with this preferred concept also the battery containment is water tight so that in an emergency—when the rupture disc is ruptured by an overpressure exceeding the rupture pressure—the battery is automatically flooded. Advantageously, it is furthermore provided that all other ambient water carrying parts continue to be water tight in order to prevent any ambient water from entering the ships body. This applies in particular to the battery containment.

During flooding of the battery, it is particularly important that the ambient water is circulated through the battery containment. In a further development of the invention, it is made sure that the heat removal is sufficient to avoid a further pressure build-up in the battery containment. Preferably, the circulation of the water occurs by natural convection that is by a natural circulation. A convection may also be supported by a pump. In particular, boiling products are conducted by the emergency cooling out of the containment to the ambient. The above-mentioned further developments provide therefore that either a boiling temperature of the ambient cooling water is prevented or boiling products such as steam or similar are discharged to the ambient without excess pressure.

Exemplary embodiments of the invention will be described below with reference to the accompanying drawings. The drawings do not necessarily represent the exemplary embodiments to scale; rather the drawings show the invention schematically for illustration of the invention. With regard to additions to the teachings illustrated in the drawings, reference is made to the respective state of the art. It is to be taken into consideration that many modifications and changes concerning the shape and detail of an embodiment may be made without deviating from the general scope of the invention. The features disclosed in the drawings and in the claims may be essential individually as well as in any combination for the further development of the invention. In addition, all combinations of at least two features disclosed in the description, the drawings and/or the claims are part of the invention. Within the scope of the invention are also all combinations of at least two features disclosed in the description, the drawings and/or the claims. The general concept of the invention is not limited to the exact form or detail of the particular preferred embodiment of a feature as described and shown below or limited to an object which would be limited in comparison to the object as defined in the claims. If dimensions are given also values in the given limits should be considered to be disclosed and applicable as desired and should be claimable. For simplicity, below identical or similar parts or parts with identical or similar functions are provided with the same reference numerals.

Further advantages, feature and particulars of the invention are apparent from the following description of preferred exemplary embodiments as well as the accompanying drawings.

### BRIEF DESCRIPTION OF THE DRAWINGS

FIG. 1A shows a general process diagram of a method for an emergency cooling and/or an emergency extinguishing of a battery of a water vehicle in accordance with a preferred embodiment,

FIG. 1B is a schematic representation of a water vehicle with a battery in accordance with a preferred embodiment for performing the method according to FIG. 1A,

FIG. 2 shows a flow diagram for an emergency cooling of the battery of a water vehicle, and

FIG. 3 shows a preferred process diagram for determining an emergency according to the preferred procedure of claim 1.

### DESCRIPTION OF EXEMPLARY EMBODIMENTS

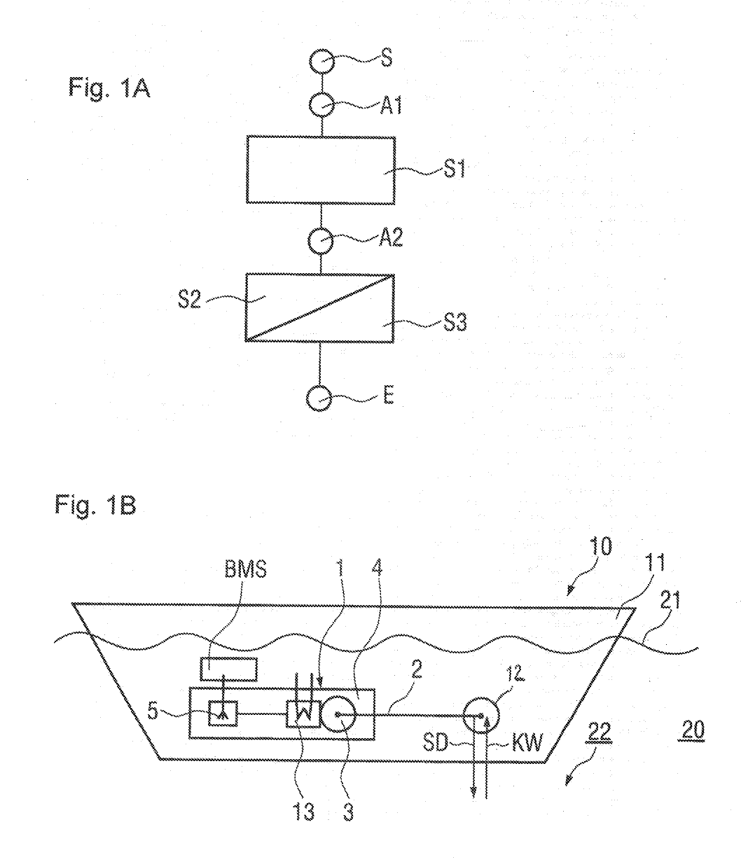

FIG. 1A shows a particularly preferred procedure for an emergency extinguishing of a battery of a water vehicle 10 as shown in FIG. 1B. A water vehicle 10 according to the present exemplary embodiment includes a lithium ion or similar battery 1 and a water vehicle body 11 of a material which is not temperature resistant. This generally applies to yachts of up to 50 m length, patrol boats or similarly ships of plastic materials such as fiber—in particular carbon fiber laminates.

In one of the exemplary embodiments, even upon failure of the operational safety arrangement of a normal cooling system 13 for the battery 1, provision must be present that the battery does not ignite uncontrollably and that, under no circumstances, heat can be released in a way that this represents a danger to the integrity of the water vehicle body 11.

It is being taken into consideration in this embodiment that, especially in connection with water vehicles 10, it is not sufficient that the battery is enclosed by the containment 4 only for a certain time, as it would be sufficient in the automotive field.

A corresponding hardware and/or software such as for example a computer program product or a corresponding sensor arrangement can be realized suitably in connection with the battery management system BMS. For example, a software model according to the flow diagram shown in FIG. 1A and FIG. 2 and FIG. 3 can be provided in a BMS within an emergency mode.

Referring to FIG. 1A, after the start S of the emergency procedure—for example triggered by the emergency management system BMS of the battery or other ambient indications—in a first step S1 an emergency is determined. Generally, in the procedure described here, an emergency is a case where a relatively high escalation state exists already, that is, the case that a pressure release of the battery 1 has occurred and/or the temperature of the battery 1 is in a range where an explosion danger exists.

In this case, in a second step S2, water 22 is drawn from the ambient 20 of the water vehicle body 11 and, in a third step S3, the battery 1 is flooded by the ambient water 22 (FIG. 1B).

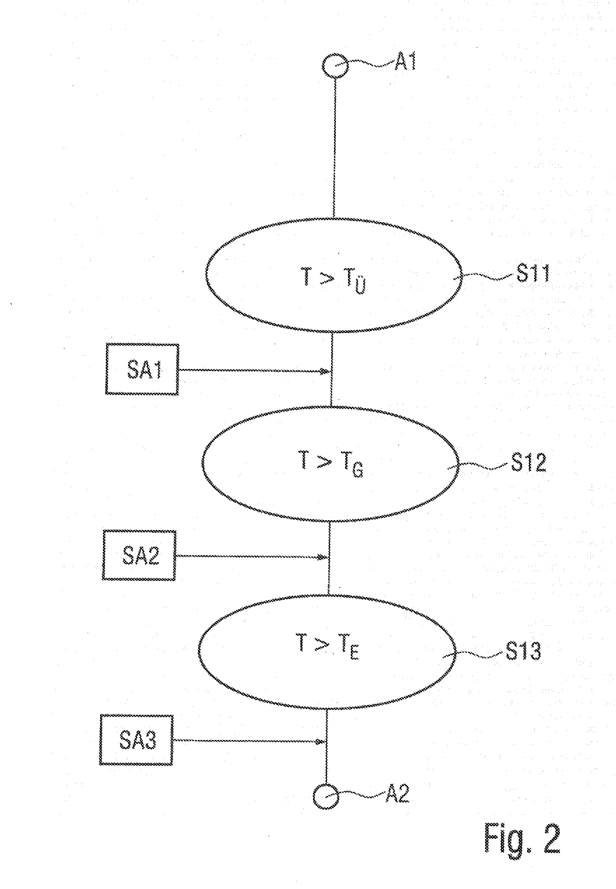

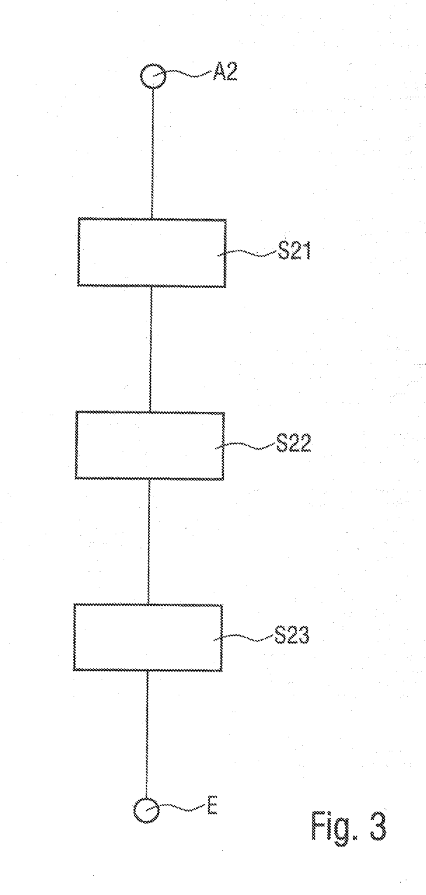

The method described in detail below with references to FIG. 2 and FIG. 3 ensures furthermore, as a result of its design, that the battery 1 is cooled as long and by a sufficient amount so that there is no danger that the fire expands to the body of the water vehicle 10, that is, for example, to the structure of the ship. On the other hand, it is ensured that no ambient water 22 enters the body of the water vehicle 10.

As shown in particular with reference to FIG. 3, the concept described herein can operate without additional operating means that is, specifically, without additional pumps or additional energy needs for supplying ambient water 22 to the battery for cooling it.

In the present case, the concept accepts that, after the flooding, the battery is damaged irreparably—it is however assumed that the battery 1 could not have been saved anyway after the emergency situation. The procedure ends with the elimination of the emergency situation.

FIG. 2 shows a further development stage of the stage S1 which may reside in a monitoring of various temperatures of the battery by the battery management system BMS. In a first step S11, an exceeding of the temperature of the battery above overheating temperature TU may be determined. Taking into consideration other ambient indicators or system information SA1, basically an emergency situation may be indicated. As presented in the embodiment as shown in FIG. 2, this is not the case.

In a second escalation stage, it is examined whether the temperature TG is at a level, where an emergency shutdown of the battery 1 is no longer possible or a battery can no longer be discharged. In this case, an emergency cooling of the battery 1 can be initiated taking into consideration other ambient indicators or system information SA2. In the example shown in FIG. 2, this is not the case either.

In the case as shown in FIG. 2, however it is determined positively that the temperature T of the battery 1 has reached a range TE where an explosion may be imminent. Such a temperature may still be determined by a temperature sensor 5 which is signal-connected to the battery management system BMS. In addition, another ambient indicator or system information value SA3 indicates that an excess pressure function has ruptured the rupture disc 3 of the battery 1 so that an excess-pressure release of the battery is in progress. This is shown in the step S21 of FIG. 3. Subsequently, an emergency flooding of the battery by ambient water 22 occurs automatically as it is shown in FIG. 3 according to step S22, since the ambient water 22 is present at a hull inlet 12 below the water line 21. Consequently, in a step S21, the flooding of the battery is initiated by the rupture of the rupture disc 3. In a step S22, the flooding of the battery 1 via the rupture opening of the rupture disc occurs automatically. To this end, as shown herein, an ambient water supply line 2 is connected to the rupture disc opening which ambient water line 2 extends to the hull inlet 12 below the water line 21. This ambient water supply line 2 which is separate from the rest of the cooling system 13 is connected to the containment 4 of the battery 1 in a water-tight manner and forms with the battery 1 a closed ambient water circuit KW. To the ambient water circuit KW, as a result, an unlimited water amount from around the water vehicle body 11 is available for cooling the battery 1. In the step S22, the battery is flooded to a sufficient extent until a fire and/or explosion danger 1 of the battery is no longer present.

In a step S23 it is furthermore ensured that the flow of ambient water 22 in the ambient water circuit KW is sufficient. In this way, also a boiling of the ambient water 22 in the battery is effectively prevented. If boiling should still occur, it is safely ensured by the design and configuration of the ambient water supply line 2, that the integrity of the water supply line as well as the containment 4, that is, the integrity of the ambient water circuit KW remains intact. Advantageously, in this regard the steam or similar is conducted by way of the ambient water supply line 2 to the ambient or it is depressurized. This procedure does not require any energy input or technical measures and safely ensures that the battery 1 is extinguished or, respectively, cooled.

Listing of Reference numerals

| SD | Steam |
|---|---|
| KW | Ambient water circuit |
| S | Start |
| E | End |
| S1, S2, S3 | Method Steps |
| S11, S12, S13 | Method Steps |
| S21, S22, S23 | Method steps |
| SA1, SA2, SA3 | System Information |
| A1, A2 | Connection |
| T | Temperature of the Battery |
| TE | Temperature in the Range of Explosion Danger |
| TG | Limit Temperature |
| TU | Overheat temperature |
| 1 | battery |
| 2 | Ambient Water Line |
| 3 | Fructure Disc |
| 4 | Containment |
| 5 | Temperature |
| 10 | Water Vehicle |
| 11 | Water Vehicle body |
| 12 | Hull Inlet |
| 13 | Cooling System |
| 20 | Ambient |
| 21 | Water Line |
| 22 | Ambient Water |

What is claimed is:

1. A method for emerging cooling a battery or emergency extinguishing a battery fire of a water vehicle (10), comprising the steps of:
determining (S1) an emergency
withdrawing (S2) ambient water (22) from the ambient (20) of the water vehicle (10) and, flooding (S3) the battery (1) with the ambient water (22).

2. The method according to claim 1, wherein an overheating of the battery (1) is determined as a case of emergency.

3. The method according to claim 1, wherein an emergency is indicated when a battery management system (BMS) can no longer perform an emergency shut-down procedure of the battery (1) or the battery can no longer be discharged.

4. The method according to claim 1, wherein an emergency is determined when the temperature of the battery (1) reaches a point where there is a danger that the battery could explode.

5. The method according to claim 1, wherein the battery (1) is flooded via an ambient water supply line (2) separate from an emergency cooling system.

6. The method according to claim 1, wherein the flooding occurs upon a pressure relief of the battery (1), especially by an automatic pressurized fluid release from the battery (1).

7. The method according to claim 5, wherein the flooding is initiated by a rupture of a rupture disc of a containment (4) of the battery (1).

8. The method according to claim 7, wherein the containment (4) is automatically filled with ambient water via the ambient water supply line (2) being connected to an opening in the ship hull below the water line of the ship hull.

9. The method according to claim 7, wherein, during flooding of the battery (1), the ambient water (22) is circulated in the containment (4) by natural circulation or by pumping.

10. The method according to claim 1, wherein during emergency cooling, boiling products are discharged from the containment (4) to the ambient (20).

11. A battery (1) including a water-tight battery containment (4) provided with an inlet for ambient water, the inlet being connectable to an ambient water supply line (2) which is separate from a closed cooling circuit system (13).

12. The battery (1) according to claim 11, wherein the inlet for the ambient water (22) is provided with a rupture disc (3) for the relief of pressure.

13. A water vehicle (10) including a battery (1) with a containment (4) having an opening closed by a rupture disc (3) the opening with the rupture disc (3) being arranged below a water line (21) of a water vehicle body (11).

14. The water vehicle (10) according to claim 13, wherein the battery (1) is arranged in the water vehicle body (11) and an ambient water supply line (2) is connected to the opening provided with the rupture disc (3) and extends to a water vehicle body outlet opening (12) which is arranged below the ambient water line (21) of the water vehicle (12).
